(19) United States
(12) Patent Application Publication
(10) Pub. No.: US 2015/0104245 A1
(43) Pub. Date: Apr. 16, 2015

(54) Securing element for securing an axial stop element on a shaft

(71) Applicant: ZF Friedrichshafen AG, Friedrichshafen (DE)

(72) Inventors: Michael Anetzberger, Hauzenberg (DE); Robert Peter, Rossbach (DE)

(21) Appl. No.: 14/510,593

(22) Filed: Oct. 9, 2014

(30) Foreign Application Priority Data
Oct. 10, 2013 (DE) 10 2013 220 393.4

(51) Int. Cl. F16D 1/06

(52) U.S. Cl. CPC F16D 1/06
USPC 403/326

(57) ABSTRACT

The invention relates to a securing element for securing an axial stop element, in particular a C-clip, radially attached to a shaft. The securing element is designed in such a manner that it is attachable to the shaft and features at least one spring-elastic axle journal, which, in the attached state of the securing element, it exerts a radial holding force for securing the axial stop element (5). A shaft device and a differential gear with such a securing element for securing an axial stop element to a shaft of the shaft device or differential gear is also provided. An axial stop element with at least one positive-locking element that is lockable with one positive-locking element of such a securing element is also provided.

### FIELD OF THE INVENTION

The invention relates to a securing element for securing an axial stop element, in particular a C-clip, radially attached to a shaft. The invention also relates to an axial stop element, in particular a C-clip, with at least one positive-locking element that is lockable with a positive-locking element of such a securing element. The invention further relates to a shaft device that features a shaft, an axial stop element attached to the shaft along with a securing element for securing the axial stop element. The invention also relates to a differential gear, within which an axial stop element is radially secured by means of a securing element.

### BACKGROUND

Axial stop elements, for example, so-called “snap rings” or “retaining rings,” are known from the state of the art. These serve as axial stops for a component allocated to the shaft, such as a bearing ring or a gear wheel. As is known, such snap rings or retaining rings can only absorb relatively small axial forces. Therefore, in order to be able to axially support larger axial forces, C-shaped or U-shaped axial stop elements are known from the state of the art. In a circumferential groove of a shaft, these are radially attached to the shaft. Compared to snap rings or retainer rings, such axial stop elements may be designed to be significantly more stable. A so-called “C-clip” forms an embodiment of such an axial stop element. C-clips are often used in axles of motor vehicles for the axial fixing of an axle shaft, also called a side shaft, in a differential gear of the vehicle axle.

The use of a C-clip in the axle of a motor vehicle can be seen, for example, in documents U.S. Pat. No. 5,131,894 A, DE 196 04 444 A1 and DE 3 901 657 A1. In FIG. 11 and the associated description, the specified document DE 3 901 657 A1 addresses in detail the exemplary design of a C-clip and its arrangement on a shaft, which is why reference is expressly made to this document in this regard.

With such C-shaped or U-shaped axial stop elements, it is disadvantageous that they are not automatically secured in a radial direction. Thus, under certain circumstances, they can fall off the shaft radially. As such, when using such an axial stop element in a vehicle axle, it is customary to provide an axial indentation in the adjacent component, for example, the respective bevel wheel. In this, the axial stop element is then pushed together with the side shaft found on it. For the removal of the side shafts from the vehicle axle, it is therefore necessary that, first, the complete side shaft is initially slid a short distance into the vehicle axle against the direction of disassembly, so that the axial stop element can be removed from the side shaft, and the side shaft can only then be removed from the vehicle axle in the direction of disassembly. Before the side shaft can be slid for the removal of the axial stop element in the vehicle axle, it is typical in the state of the art that a differential pin of the vehicle axle must be removed, which represents a considerable expense.

EP 1 717 485 B1 proposes a special mounting arrangement for the radial securing of axial stop elements, here C-clips, in a vehicle axle. These have a cylinder-shaped spacer and a ring surrounding the spacer. The ring and the spacer are able to be turned relative to each other and are able to be screwed into each other. If the ring and the spacer are in a location relative to each other, the mounting arrangement can be attached to the axial stop elements. Subsequently, the ring and the spacer are turned and screwed relative to each other, in order to radially secure the axial stop elements.

Such a mounting arrangement occupies a large installation space. It must be individually adjusted to almost any type of vehicle axle, in order to find space therein. This is relatively expensive. Therefore, the task of the invention is to improve the state of the art, at least in this regard.

### SUMMARY OF THE INVENTION

Objects and advantages of the invention will be set forth in part in the following description, or may be obvious from the description, or may be learned through practice of the invention. The tasks are solved by a securing element with the characteristics set forth herein. The tasks are solved by an axial stop element with the characteristics described herein. The tasks are also solved by a shaft device with the characteristics set forth herein. The tasks are also solved by a differential gear with the characteristics described herein. Preferred embodiments thereof are set forth below.

Accordingly, a securing element for securing an axial stop element radially attached to a shaft is proposed. The securing element is designed in such a manner that it is attachable to the shaft, in particular radially attachable. Thereby, the securing element features at least one spring-elastic axle journal. The spring-elastic axle journal is designed in such a manner that it exerts a radial holding force on the axial stop element for its securing on the shaft, if the securing element is arranged on the shaft and the axial stop element, in particular attached to it. The holding force may comprise in particular a spring force of the at least one axle journal. The securing of the axial stop element through the securing element may in particular exist in a purely radial securing.

Additionally or in the alternative, the radial holding force may also be generated by means of a locking of the spring-elastic axle journal. In this case, the spring-elastic axle journal is designed to be lockable with at least one axial stop element, and optionally also with the shaft. In this case, the securing element locks with the axial stop element in its attached state, and thereby generates the radial holding force. The securing element is designed in particular in such a manner that it exerts a radial holding force on the axial stop element, thus not an axial holding force. Thus, the securing element is used purely for the radial fixing of the axial stop element on the shaft.

Upon the use of the securing element in an axle of a motor vehicle, the axial stop element may be easily installed and removed in an operating position of the respective axle shaft. For disassembly, it is sufficient that the securing element is removed from the axial stop element. Subsequently, the axial stop element may be radially removed from the axle shaft. It is then no longer necessary to initially expensively remove a differential pin of the motor vehicle axle. It also eliminates the need to move the respective axle shaft counter to the direction of disassembly, in order to reach the axial stop element, since this is then freely accessible after the removal of the securing element and radially removable from the axle shaft.

The axial stop element may comprise a C-shaped or U-shaped axial stop element. Accordingly, the axial stop element in particular may comprise a C-clip or the like. The securing element in particular may be designed to be attachable radially or axially on the shaft and the axial stop element. However, the securing element may also be designed to be attachable radially or axially on the shaft and the axial stop element, i.e. both assembly directions are usable by means of such an axial stop element. The attached state of the securing element exists in particular if, in accordance with its intended use, it is arranged on the shaft and the axial stop element, in particular if it is attached to both. The axle journal may be designed to be spring-elastic, in particular in areas. However, it essentially may be designed to be completely spring-elastic. It may also have one or more spring-elastic joints, in order provide the spring elasticity.

The term “radial” is to be understood, in particular, in the sense of on the side of the shaft. Accordingly, the securing element or the axial stop element, if it is radially attached to the shaft, is attached to this from a side surface of the shaft, for example along an orthogonal of a longitudinal axle of a shaft or a rotational axle of a shaft. Accordingly, the term “axial” is to be understood, in particular, in the sense of at the front of the shaft. Accordingly, the securing element or the axial stop element, if it is axially attached to the shaft, is attached to this from a front side of the shaft, for example along or parallel to a longitudinal axle of a shaft or a rotational axle of a shaft.

The securing element in particular may be a component of the axial stop element. For this purpose, the securing element may be securely fastened with, for example, the axial stop element, and form a common structural unit with this. In this case, it is designed in such a manner that it is attachable to the shaft together with the axial stop element. For this purpose, the securing element may be connected with the axial stop element, preferably in a positive-locking or firmly bonded manner. For example, the securing element may be cast or molded to the axial stop element with casting technology, or riveted or bolted with this. The axial stop element then includes the securing element, by means of which the assembly of the axial stop element on the shaft is simplified through the lower number of individual parts necessary. Therefore, the invention may also refer to a common structural unit made of an axial stop element and the described securing element, which are firmly connected to each other, in particular connected in a firmly bonded manner.

The securing element may also form a standalone component. This means that it is neither a component of the shaft, nor of the axial stop element, nor of another component. At that point, the securing element is able to be used universally, for example, for various types or sizes of axial stop elements. It may be designed in such a manner that it is attached to the shaft and the axial stop element already found on it, in order to generate the (radial) holding force on the axial stop element. Alternatively, the securing element may also be designed in such a manner that it is first attached to the axial stop element before it is attached to the shaft together with the securing element, in order to generate the (radial) holding force on the axial stop element. Or, the securing element alternatively may be designed in such manner that it is first attached to the shaft before the axial stop element is attached to the shaft and the securing element found on it, in order to generate the (radial) holding force on the axial stop element.

The securing element may consist of a homogeneous material, in particular plastic or metal. In particular, plastics with a low tendency to creep may be used, in order to maintain the holding force for as long as possible. The same applies to metals. Therefore, for example, a Duromer product or a similarly dense cross-linked polymer material is suitable as a plastic material. Therefore, for example, a spring steel is suitable as a metal material. However, the use of other appropriate materials is also possible. The securing element may also consist of an non-homogeneous material, such as a composite material. For example, it may consist of a CFRP or a GRP material (CFRP: carbon-fiber-reinforced plastic; GRP: glass-fiber-reinforced plastic). The securing element may also consist of an inlay made of a metal material with a shell made of a plastic material. Thereby, the shell of the inlay may be applied at the inlay by means of injection molding technology.

The securing element may also feature a coating. This may comprise, in particular, a coating for improving the abrasion resistance or improving the resistance to environmental influences, such as oils, gasses or water, and/or components thereof (salts, additives, etc.). In particular, the coating may have been applied by painting, anodizing, passivation or electroplating, etc.

The securing element may feature, in particular, at least one first spring-elastic axle journal, which is designed in such a manner that, in the attached state of the securing element, the axial stop element encloses, at least in part, in particular an outer circumference of the axial stop element. In other words, this first axle journal then has an inner side, which abuts on an outer side or an outer circumference of the axial stop element and encloses this, if the securing element is arranged on the axial stop element. This improves the hold of the securing element on the axial stop element. Preferably, the securing element has two such first spring-elastic axle journals, which together enclose the axial stop element, at least in part. This encloses the axial stop element, in particular in different circumferential directions, i.e., one of the first axle journals encloses the axial stop element in a clockwise direction, while the other of the first axle journals encloses the axial stop element in a counter-clockwise direction. Between the ends of the two first axle journals, a gap is provided, through which the securing element is attachable to the axial stop element.

The securing element may have two first axle journals along with one connection piece of the two first axle journals, whereas the connection piece features a molding on the inner side; this is designed to engage in a circumferential groove of the shaft. Thus, the connection piece combines the two first spring-elastic axle journals. Thereby, it does not also need to be spring-elastic. On its inner side at the shaft, the connection piece has a molding, which may be designed, for example, as a lug or the like. The molding is designed in such a manner that it engages in a circumferential groove in the shaft, if the securing element is arranged on the shaft. Thereby, the securing element is fixed axially on the shaft, without absorbing the axial forces of the axial stop element. This may comprise, in particular, that circumferential groove of the shaft that is used for the attachment of the axial stop element. Preferably, the molding of the connection piece may have a larger width compared to the two first axle journals. The width of the molding may correspond to, in particular, the width of the circumferential groove of the shaft, which is used to attach the axial stop element.

The securing element may have, in particular, only these two first axle journals; i.e., it may not feature any additional such first axle journals. It may also be provided that the securing element, as a whole, has only these two first axle journals; i.e., as a whole, it may not feature any additional axle journals.

The securing element may feature, in addition to the first spring-elastic axle journal(s), at least one second spring-elastic axle journal. This is designed in such a manner that, in the attached state of the securing element, it encloses the shaft at least in parts. In detail, this second axle journal has an inner side, which abuts on an outer side or an outer circumference of the shaft and thereby encloses this, if the securing element is arranged on the shaft. This improves the hold of the securing element at the shaft. Preferably, the securing element has two such second spring-elastic axle journals, which together enclose the shaft, at least in part. They enclose the shaft, in particular in different circumferential directions; i.e., one of the second axle journals encloses the shaft in a clockwise direction, while the other second axle journal encloses the shaft in a counter-clockwise direction. Between the ends of the two second axle journals, a gap is provided, through which the securing element is attachable to the shaft.

The securing element may have, in particular, only such two second axle journals; i.e., it may not feature any additional such second axle journals. It may then also be provided that the securing element, as a whole, has only two first axle journals and two second axle journals; i.e., as a whole, it may not feature any additional axle journals.

The securing element may have a common connection piece of the two first axle journals and the two second axle journals, which combines the two first axle journals with the two second axle journals, in a manner axially spaced from one another. Thereby, it does not also need to be spring-elastic. Thereby, the hold of the securing element on the shaft and the axial stop element is improved, and the risk of tipping of the securing element is reduced. The two first and second axle journals emanate in particular from the connection piece; i.e. the connection piece forms the base of the axle journals. The connection piece may have the already mentioned molding, which is designed to engage in a circumferential groove of the shaft.

The securing element may feature at least one axial contact surface for the axial application at the side surface of the axial stop element. In particular, one or both of the first axle journals may have such a contact surface, and/or the connection piece of the axle journal may have such a contact surface. Optionally, one or both of the second axle journals may have such a contact surface. The contact surface is molded in such a manner that the securing element thus abuts on a side surface of the axial stop element, if the securing element is arranged on the axial stop element. Thereby, the securing element is fixed on the axial stop element, at least in an axial direction. If the axial stop element is designed as a C-clip, the side surface comprises, for example, a side cheek of the C-clip, on which the securing element abuts with the contact surface.

It may also be provided that the securing element features at least two opposing axial surfaces, for the two-sided application at the two opposing axial side surfaces of the axial stop element. These contact surfaces may be located, in particular, at one or both of the first or second axle journals and/or at the connection piece of the axle journal. Thereby, the securing element is axially fixed in two directions on the axial stop element, and may no longer axially slip if it is arranged thereon.

The (first/second) spring-elastic axle journal(s) may be designed in such a manner that, through this (these), the securing element encloses the axial stop element or the shaft by a total of less than 180°. This means that if only one spring-elastic axle journal is provided, this is solely designed in such a manner that the securing element thus encloses the axial stop element or the shaft by a total of less than 180°, if it is arranged on the axial stop element or the shaft. In addition, if two (first/second) spring-elastic axle journals are provided, these are designed in such a manner that the securing element thus encloses the axial stop element or the shaft by a total of less than 180°, if the securing element is arranged on the axial stop element or the shaft. Thereby, the securing element may be designed to be very compact. An enclosure of less than 180° means, for example, that the axle journal(s) enclose(s) the shaft or the axial stop element by less than half of the total outer circumference.

The (first/second) spring-elastic axle journal(s) may also be designed in such a manner that, through this (these), the securing element encloses the axial stop element or the shaft by a total of exactly 180°, or more than 180°. This means that if only one spring-elastic axle journal is provided, this is solely designed in such a manner that the securing element thus encloses the axial stop element or the shaft by a total of more than 180°, or exactly 180°, if it is arranged on the axial stop element or the shaft. In addition, if two (first/second) spring-elastic axle journals are provided, these are designed in such a manner that the securing element thus encloses the axial stop element or the shaft by a total of more than 180° or exactly 180°, if it is arranged on the axial stop element or the shaft. Thereby, the securing element abuts particularly securely on the shaft or the axial stop element. An enclosure of more than 180° means, for example, that the axle journal(s) enclose(s) the shaft or the axial stop element by more than half of the total outer circumference.

For example, the first axle journal may be designed in such a manner that, through this, the securing element encloses the axial stop element by less than 180°, or more than 180°, or exactly 180°, if it is arranged thereon. In addition, the second axle journal may be designed in such a manner that, for example, through this, the securing element encloses the shaft by a total of less than 180° or more than 180°, or exactly 180°, if it is arranged thereon. If the securing element features first and second axle journals, these can also be designed in such a manner that, if the securing element is arranged on the shaft and the axial stop element, this encloses the axial stop element and the shaft to a varying extent. In particular, the securing element may, through the one pair of axle journals, enclose the respective component (i.e. the shaft or the axial stop element) by more than 180° or exactly 180°, and through the other pair of axle journals, enclose the respective component (i.e. the axial stop element or the shaft) by less than 180°.

Preferably, the spring-elastic axle journal(s) is (are) designed in such a manner that, through this (these), in the attached state of the securing element, the securing element fully encloses an outer circumference of the axial stop element. Thereby, the securing element has a particularly good hold on the axial stop element. If two first axle journals are provided, in the attached state of the securing element, for example together with the connection piece connecting the two axle journals, they jointly fully enclose the axial stop element. With a C-shaped or U-shaped axial stop element, this means that the securing element is designed in such a manner that it encloses the axial stop element to the extent that the axial stop element itself encloses the shaft.

In principle, the (first/second) spring-elastic axle journal(s) may feature at least one positive-locking element, in particular an inner surface or inner side of the respective axle journal. This may comprise, in particular, a hook or a notch or a loop, to name only a few options as examples. The positive-locking element is then designed in such a manner that it is lockable with the axial stop element and/or the shaft. This means that, in a first embodiment, the positive-locking element is designed in such a manner that it locks solely with the axial stop element. Or, in a second embodiment, it is designed in such a manner that is locks solely with the shaft. Or, in a third embodiment, it is designed in such a manner that it locks both with the shaft and with the axial stop element. Thereby, the hold of the securing element at the shaft or the axial stop element can be significantly improved. Accordingly, the inner side of the axle journal comprises in particular a side turned towards the axial stop element or the shaft, if the securing element is arranged thereon. If two first axle journals are provided, each of the one or both of the first axle journals features at least one such positive-locking element for locking with the axial stop element. If two second axle journals are provided, each of the one or both of the second axle journals may feature at least one such positive-locking element for locking with the shaft. If two first or second axle journals are provided, they can also be designed in such a manner that one of the axle journals is able to be locked with the other axle journal.

The invention also relates to an axial stop element, in particular a C-clip, with at least one positive-locking element, which is lockable with the corresponding positive-locking element of the securing element in accordance with the invention (in particular with the positive-locking element of the first axle journal(s)). As such, the positive-locking element of the axial stop element comprises in particular an element that is designed to complement the positive-locking element of the securing element. Thus, the positive-locking elements of the axial stop element and the securing element work in accordance with a key-lock principle. Upon the joining, for example the plugging together, of the securing element and the axial stop element, each positive-locking element locks together, whereupon the two components are firmly connected to one another at least in a radial direction. The positive-locking element of the axial stop element may also comprise a hook or a notch or a loop, to name only a few options as examples.

The invention may also relate to a shaft, which features at least one positive-locking element, which is lockable with a corresponding positive-locking element of the securing element in accordance with the invention (in particular with the positive-locking element of the second axle journal(s)). As such, the positive-locking element of the shaft comprises in particular an element that is designed to complement the respective positive-locking element of the securing element. Thus, the positive-locking elements of the shaft and the securing element work in accordance with a key-lock principle. Upon the joining, for example the plugging together, of the securing element and the shaft, the respective positive-locking elements lock together, whereupon the two components are firmly connected to one another at least in a radial direction. The positive-locking element of the shaft may also comprise a hook or a notch or a loop, to name only a few options as examples.

The invention also relates to a shaft device that has at least has one shaft and one axial stop element radially attached to the shaft, along with a securing element attached to the shaft and the axial stop element. The securing element comprises the previously described securing element in accordance with the invention. The securing element secures the axial stop element radially to the shaft, in particular in its radial attaching direction. The axial stop element may comprise in particular the axial stop element described above, with at least one positive-locking element for locking with the securing element. The shaft may comprise in particular a shaft of a vehicle differential gear.

The invention also relates to a differential gear, in particular a motor vehicle differential gear, for example, for a motor vehicle axle. This may comprise in particular a rigid axle of a vehicle. The differential gear features at least one drivable input shaft and two drivable output shafts, along with one rotatably mounted differential gear cage. The differential gear cage is rotatably drivable from the input shaft. Thereby, within the differential gear cage, at least two differential gear wheels are arranged; by means of these, two output shafts are rotatably drivable. For this purpose, each of the differential gear wheels is firmly connected in a positive-locking manner with one of the output shafts. In addition, each of the differential gear wheels is fixed with this output shaft by means of an axial stop element in an axial direction. Thereby, it is provided that each of the axial stop elements is radially secured through the previously described securing element in accordance with the invention, thus in the direction of attachment of the axial stop element. This facilitates the assembly and disassembly of the differential gear. In particular, the axial stop elements are then able to be installed and removed in the operating position of the output shaft.

The invention may accordingly relate to the use of the previously described securing element in accordance with the invention in a differential gear, in particular an automotive differential gear, or in a motor vehicle axle, or in a vehicle in general, for the radial securing of an axial stop element contained therein.

For the preferred assembly of the differential gear, initially, the output shafts in the differential gear cage and the differential gear wheels contained therein are axially introduced. Then, the axial stop element is radially attached at the respective output shaft. For this purpose, window-like openings may be provided in the differential gear cage. Then, at each pair of one axial stop element and one output shaft, a securing element in accordance with the invention is attached for the radial securing of the axial stop element on the shaft. Alternatively, the securing element may be attached on the axial stop element before this is radially attached, together with the securing element, at the respective output shaft. The disassembly takes place in reverse order. The attachment of the securing element preferably takes place radially at the output shaft, analogous to the attachment of a C-shaped or U-shaped axial stop element. Upon disassembly, it is then no longer necessary to have to remove a differential pin of the differential gear before removing the axial stop elements.

In the present invention, with the term “can,” optional additional forms of the invention, which have the indicated characteristics or features, are identified in particular.

### BRIEF DESCRIPTION OF THE DRAWINGS

In the following, the invention is more specifically described based on examples and drawings, from which additional advantageous arrangements and characteristics of the invention may be derived. The following are shown, each in schematic presentation,

FIG. 1 a sectional view through a conventional differential gear;

FIG. 2 a three-dimensional view of a shaft with a bevel wheel and an axial stop element found thereon;

FIG. 3 a three-dimensional view of a first version of a securing element on a shaft and on an axial stop element;

FIG. 3a an additional three-dimensional view of the securing element and the shaft and the axial stop element of FIG. 3;

FIG. 3b a three-dimensional view of the securing element from FIGS. 3 and 3a;

FIG. 4 a three-dimensional view of a second version of a securing element on a shaft and on an axial stop element;

FIG. 4a a three-dimensional view of a continuation of the securing element from FIG. 4;

FIG. 4b an additional three-dimensional view of the securing element from FIG. 4a;

FIG. 4c a view of the securing element from FIGS. 4a and 4b on a shaft and an axial stop element;

FIG. 5 a sectional view through a differential gear with a securing element.

In the figures, equivalent or at least functionally equivalent parts/components are provided with the same reference signs.

### DETAILED DESCRIPTION

Reference will now be made to embodiments of the invention, one or more examples of which are shown in the drawings. Each embodiment is provided by way of explanation of the invention, and not as a limitation of the invention. For example features illustrated or described as part of one embodiment can be combined with another embodiment to yield still another embodiment. It is intended that the present invention include these and other modifications and variations to the embodiments described herein.

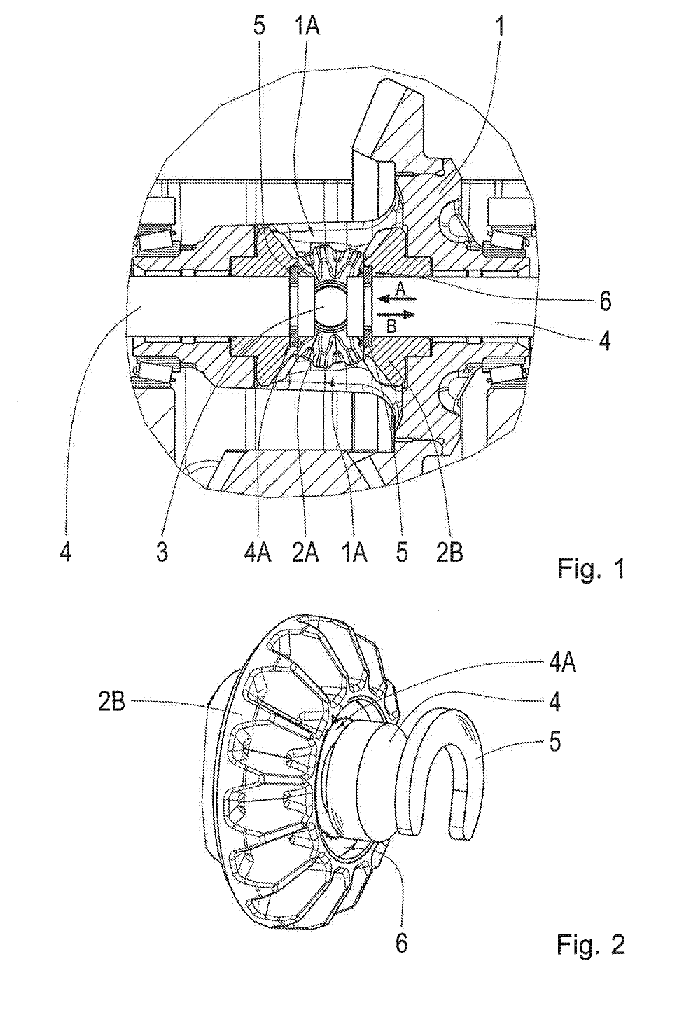

FIG. 1 shows a section through a conventional differential gear in a vehicle axle, for example, a rear axle designed as a rigid axle. The differential gear has a differential cage 1 drivable through an input shaft (not shown). The cage 1 is rotatably mounted within the differential gear through two engaged bearings. Differential gear wheels 2A, 2B, here bevel wheels, are arranged within the differential cage 1 in a known manner. Of these, at least two (see gear wheel 2A) are rotatably mounted on a differential pin 3, and two are firmly connected in a positive-locking manner with one axle shaft 4 each, also called a side shaft. For this purpose, at the outer circumference, the shaft 4 features an outer spline shaft tooth system, and the gear wheel 2B features a corresponding, complementary inner spline shaft tooth system.

For the axial fixing of the axle shaft 4 and the gear wheel 2b, in each case, one axial stop element 5 (see also FIG. 2), here in the form of a so-called “C-clip,” is provided. Upon the assembly of the vehicle axle, these are inserted radially into a circumferential groove 4A of the axle shaft 4. For this purpose, initially, the shaft 4 must be axially introduced into the differential cage 1 and the respective gear wheel 2B (arrow A), namely to the extent that the groove 4A is accessible inside the differential cage 1 through a window-like opening 1A of the differential cage 1. Then, the axial stop element 5 may be attached radially on the shaft 4 or in the circumferential groove 4A. Then, in order to prevent the axial stop element 5 from slipping from the shaft 4, the shaft 4 must be pulled out a short distance axially from the differential cage 1 (arrow B), such that the axial stop element 5 arrives in an axial indentation 6 in the respective adjacent gear wheel 2B (as shown in FIG. 1). Thus, the axial stop element 5 is radially secured. Finally, the differential pin 3 must be installed in the differential cage 1.

The disassembly takes place in reverse order. This means that, for the disengagement of the axle shafts 4 from the vehicle axle, the differential pin 3 initially must be removed from the differential cage 1. Then, the respective axle shaft 4 must be slid a short distance into the differential cage 1 (arrow A), until the axial stop element 5 slips from the indentation 6 of the respective gear wheel 2B, and it is thereby accessible and radially removable. Only after the removal of the axial stop element 5 can the axle shaft 4 finally be pulled out of the differential cage 1 (arrow B), and thus released from the vehicle axle. In particular, a considerable amount of work arises through the necessary prior removal of the differential pin 3.

FIG. 2 shows an enlarged three-dimensional view of the end of the axle shaft 4 from FIG. 1 with the circumferential groove 4A incorporated therein along with the gear wheel 2B (bevel wheel) arranged on the shaft 4. As an example, in addition to the shaft 4 and the gear wheel 2B, a C-shaped axial stop element is shown, for the radial attachment on the shaft 4 or the radial insertion into the groove 4a. In detail, this comprises a so-called “C-clip.” Its outer circumference is C-shaped or shaped as a partial circle, while an inner circumference, with which it abuts in the circumferential groove 4A, is U-shaped. Through this open shape, it may be radially attached to the shaft 4 and, in contrast to a retaining ring or a snap ring, does not need to be bent open in a spring-elastic manner for assembly. Thereby, a C-clip may be designed to be significantly more stable, and accordingly may absorb higher axial forces. One disadvantage is that, without extra radial securing, it can be lost. Therefore, the axial indentation 6 is provided in the wheel gear 2A; this radially encloses the C-clip in the assembled state.

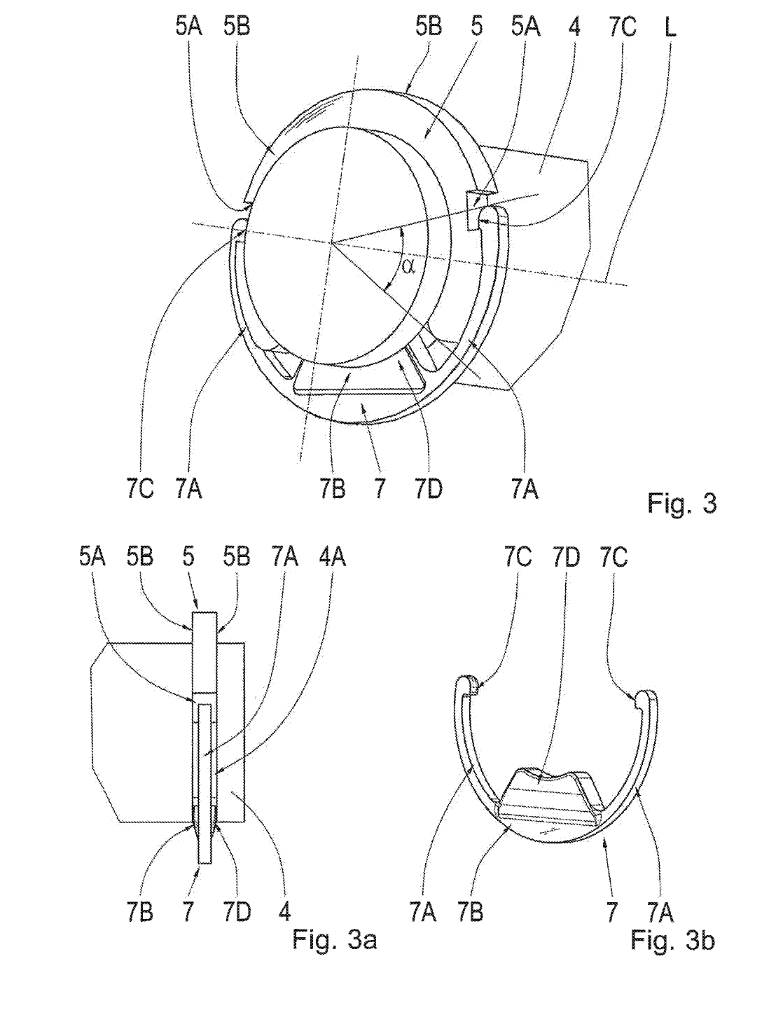

FIGS. 3, 3a, 3b show a first embodiment of a securing element 7 for the radial securing of an axial stop element 5 attachable radially on a shaft 4. Thereby, FIG. 3 shows a shaft device consisting of the shaft 4, the axial stop element 5 and the securing element 7, while FIGS. 3a and 3b show only the securing element 7. The axial stop element 5 is shown as a C-clip, solely as an example. Analogous to FIGS. 1 and 2, the axial stop element 5 is attached radially on the shaft 4; in detail, it is inserted into a circumferential groove 4a of the shaft 4. Thereby, it forms an axial stop for a component arranged on the shaft, such as a gear wheel or a bearing ring, etc. (not shown here). The securing element 7 of FIGS. 3 to 3b is designed in such a manner that it is attached to the shaft 4 and the axial stop element 5 together, i.e., after the axial stop element 5 has been arranged on the shaft 4. Accordingly, the securing element 7 thus forms a component independent of the shaft 4 and the axial stop element 5.

The securing element 7 features two first spring-elastic axle journals 7A. Through the spring elasticity, the axle journals 7A can be bent open, such that the securing element 7 can be applied to the shaft 4 and the axial stop element 5. In the present case, this may be alternately effected through an axial and/or a radial attachment. In the attached state that is shown of the securing element 7, a radial holding force at the axial force element is generated through the axle journal 7A. For this purpose, each of the axle journals 7A encloses an outer circumference of the axial stop element 5. The angle by which each of the axle journals 7A encloses the outer circumference is marked with a. Since, in the example shown, both axle journals 7A enclose the outer circumference in an equally wide extent, the axial stop element 5 is enclosed by the securing element 7 by a total 2a. However, it can also be provided that the axle journals 7A enclose the axial stop element 5 to a varying extent. In the embodiment shown, it arises that the securing element 7 encloses the axial stop element 5 by means of the axle journal 7A by a total of less than 180°. It is also possible that, through the axle journal 7A, the securing element 7 encloses the axial stop element 5 by a total of exactly 180° or by a total of more than 180°.

The axle journals 7A enclose the axial stop element 5 in different circumferential directions. Thus, one of the axle journals 7A encloses the axial stop element 5 in a clockwise direction, and the other axle journal 7A encloses the axial stop element 5 in a counter-clockwise direction.

Each of the axle journals 7A preferably has, in its end area, a positive-locking element 7C, here for example a hook, which is designed to lock in a corresponding positive-locking element 5A of the axial stop element 5, for example a notch, if the securing element 7 is found in the attached state that is shown. Accordingly, the positive-locking elements 5A, 7C are designed to complement each other (key-lock principle). Alternatively, for each axle journal 7A, several positive-locking elements 5A, 7C are provided in order to generate a greater holding force. In addition, the positive-locking elements 5A, 7C may be otherwise suitable in any other way, but designed to fit each other. For example, the axial stop element 5 may have one or more hooks, and the respective axle journal 7A may have at least one loop or notch corresponding to these. It is also possible to dispense with the positive-locking shifting elements 7C. At that point, the securing element 7 is preferably designed in such a manner that, by means of the axle journal 7A, it encloses the axial stop element 5 by a total of more than 180°. In this case, the (radial) holding force of the securing element 7 is generated by the spring force of the axle journal 7A.

The securing element 7 also has a connection piece 7B for the two first axle journals 7A. Like the axle journal 7A, this may be designed in a spring-elastic manner. It also may be designed to be significantly stiffer than the axle journal 7A. At its inner side turned towards the shaft 4, the connection piece 7B features a molding 7D, which is designed to engage in the circumferential groove 4A of the shaft 4. The connection piece 7B or the molding 7D preferably has a greater (axial) width than the axle journal 7A (see, in particular, FIG. 3a). Preferably, the width of the molding 7D corresponds to the width of the circumferential groove 4A. Thus, the securing element 7 abuts securely in the groove 4A, and axial slippage is nearly ruled out.

It is also possible to dispense with one of the axle journals 7A. In this case, the securing element features an axle journal 7A along with the connection piece 7B, which then forms an end area of the remaining axle journal 7A. In this case, it is preferably provided that, with the remaining axle journal 7A, the securing element 7 further encloses the axial stop element 5 in the attached state, as this is shown in FIGS. 3 and 3a, for example, by exactly 180° or more than 180°.

The securing element 7 may, in principle, also have at least one axial contact surface, for the axial application at the side surface 5B or at the two opposing sides 5B (=cheeks) of the axial stop element 5 (not shown in FIGS. 3, 3a, 3b). This contact surface may be provided on one or both axle journals 7A. As an alternative or in addition, the contact surface may also be provided on the connection piece 7B.

As can be seen in FIGS. 3, 3a, in the attached state of the securing element 7, the connection piece 7B is aligned at the axial stop element 5 in such a manner that, in the attached state of the securing element 7, the connection piece 7B is found at the open side of the axial stop element 5, with which the axial stop element 5 has been attached on the shaft 4. However, as shown in the following embodiments, this is not absolutely necessary.

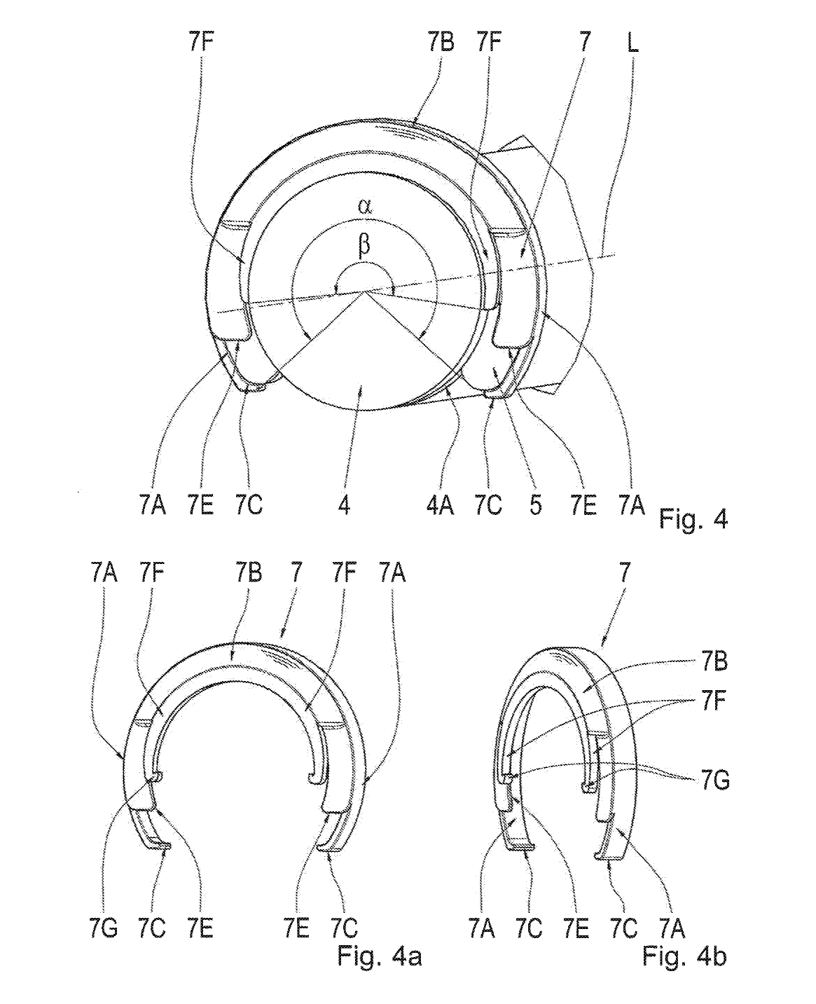

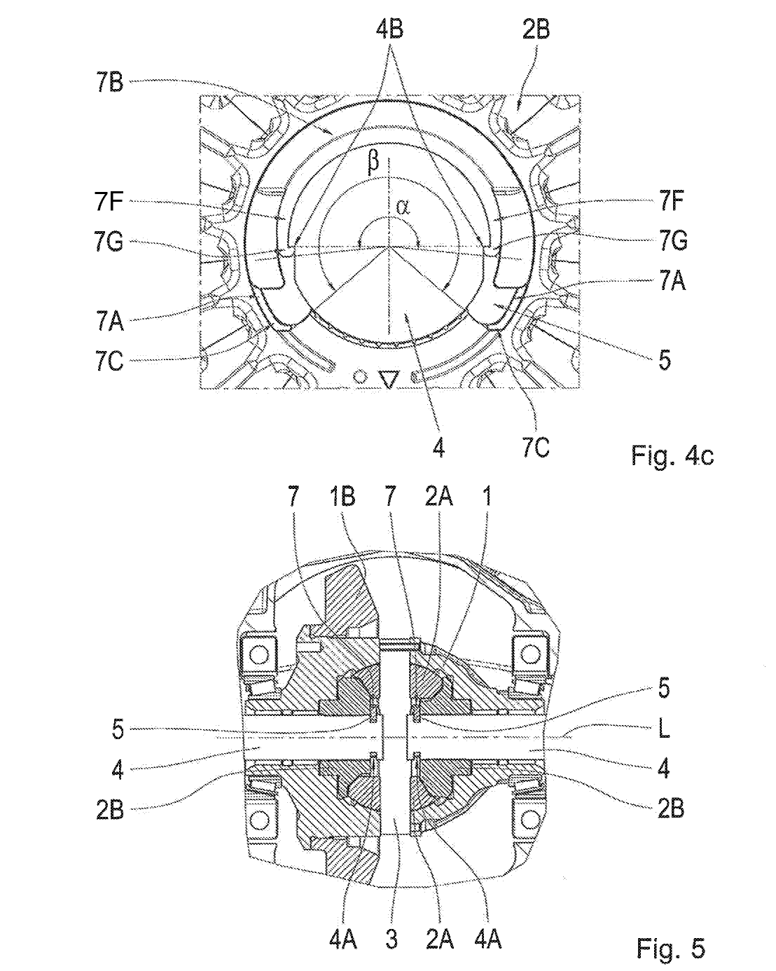

FIG. 4 shows an embodiment of a securing element 7 for an axial stop element 5 on a shaft 4. Therefore, FIG. 5 shows an additional type of shaft device consisting of the shaft 4, the axial stop element 5 and the securing element 7. Analogous to FIG. 3, the axial stop element 5 is inserted into a circumferential groove 4A of the shaft 4, and thereby forms an axial stop for an additional component that is not shown. The securing element of FIG. 4 is designed in such a manner that it can both be attached to the axial stop element 5 and then, together with this, to the shaft 4, and can be attached to the shaft with the axial stop element 5 already arranged thereon.

The securing element 7 has two first spring-elastic axle journals 7A, which, in the attached state that is shown of the securing element 7, apply a (radial) holding force to the axial stop element 5, through which this is radially secured to the shaft 4. Through the spring elasticity, the axle journals 7A can be bent open, such that the securing element 7 can be attached to the shaft 4 and the axial stop element 5. The axle journals 7A then enclose the axial stop element 5 in different circumferential directions. Thus, one of the axle journals 7A encloses the axial stop element 5 in a clockwise direction, and the other axle journal 7A encloses the axial stop element 5 in a counter-clockwise direction. In the embodiment shown, the first axle journals 7A are designed in such a manner that they essentially fully enclose the axial stop element 5 (see angle α). Thus, the securing element 7 encloses the axial stop element 5 by means of the axle journal 7A by a total of more than 180°. However, it is also possible that, through the axle journals 7A, the securing element 7 encloses the axial stop element 5 by a total of exactly 180° or by a total of less than 180°.

The ends of the first axle journal 7A are bent inwards, by which the ends form positive-locking elements 7C, which are lockable with the axial stop element 5, here with the end areas of the axle journal of the axial stop element 5. As such, in the embodiment shown, the axial stop element 5 itself does not feature any special corresponding positive-locking shifting elements. However, the first axle journals 7A may also be designed analogously to that of FIGS. 3 to 3b. In this case, the axial stop element 5 comprised corresponding extra positive-locking elements 5A. Optionally, each of the first axle journals 7A has the shown axial contact surface 7E for the axial stop element 5. Thereto, in the attached state, the securing element 7 axially abuts on a side surface 5B (=cheek) of the axial stop element 5. More such contact surfaces 7E can be provided on the securing element 7, for example, for the axial application of the securing element on the two opposing side surfaces 5B of the axial stop element 5. As an alternative or in addition to the contact surface 7E on the respective axle journal 7A, one or more contact surfaces 7E may also be provided on the connection piece 7B of the two axle journals 7A.

According to the embodiment of FIG. 4, the securing element 7 may have two second axle journals 7F. Through the spring elasticity, the axle journals 7F can be bent open, such that the securing element 7 can be attached to the shaft 4 and the axial stop element 5. In the attached state of the securing element 7, the axle journals 7F enclose the shaft 4. Thereby, the securing element 7 is fixed radially on the shaft 4. The second axle journal 7F may be designed analogously to the first axle journals 7A. One of the second axle journals 7F encloses the shaft 4 in a clockwise direction, and the other of the axle journals 7F encloses the shaft 4 in a counter-clockwise direction. In the example shown, neither of the second axle journals 7F features a special positive-locking element, through which it is lockable with the shaft 4. Instead of this, the securing element 7 encloses the shaft 4 by means of the second axle journal 7F to the extent that a sufficient radial holding force is provided for the holding of the securing element 7 on the shaft 4. Depending on the friction conditions between the securing element 7 and the shaft 4, it may be sufficient if the securing element encloses the shaft with the axle journals 7F by less than 180°, or by exactly 180°. In the present case, it encloses the shaft by more than 180° (see angle β). In this regard, it emerges from FIG. 4 that, in the attached state, the securing element 7 may enclose the shaft 4 and the axial stop element 5 to a varying extent see difference between angle α and β). It is possible to dispense with one of the axle journals 7A, 7F. At that point, the remaining axle journal 7A, 7F further encloses the shaft 4 or the axial stop element 5, as shown in FIG. 4.

At the same time, the connection piece 7B of the two first axle journals 7A also forms a connection piece of the two second axle journals 7F. Thereby, the connection piece 7B is designed in such a manner that the first axle journals 7A and the second axle journals 7F are spaced axially from one another.

FIGS. 4a, 4b and 4 c show a slight variation of the securing element 7 from FIG. 4. Therefore, the circumstances specified for execution in accordance with FIG. 4 also apply as far as possible to the execution in accordance with FIGS. 4a to 4c. As the only difference, in accordance with FIGS. 4a and 4b, each of the second axle journals 7E features a positive-locking element 7G, for locking with the shaft 4, in detail for locking with special corresponding, complementary positive-locking elements 4B of the shaft 4. These are visible in FIG. 4c. FIG. 4c thereby shows a front-side view of a shaft 4, an axial stop element 5 and a securing element 7 in the attached state. A bevel wheel 2B is visible in the background; this is axially fixed to the shaft 4 by the axial stop element 5. Here, as an example, the positive-locking shifting elements 4B of the shaft 4 are designed as lateral notches. The positive-locking shifting elements 7G of the second axle journals 7F are designed here, for example, as hooks, which engage in the lateral notches of the shaft 4. However, the positive-locking shifting elements 4B, 7G may feature any other suitable form, for example, they can be designed in the form of a loop, a notch, etc.

In principle, it can be provided that each of the axle journals 7A, 7F of the securing element 7 may not have a positive-locking element 7C, 7G. Thereby, the radial holding force on the axial stop element 5 or the shaft 4 acts solely through the spring force of the respective axle journal 7A, 7F. In this case, the securing element 7 is preferably designed in such a manner that this encloses the axial stop element 5 or the shaft 4 by means of the axle journal 7A, 7F by a total of more than 180°.

FIG. 5 shows the use of the securing element shown in FIGS. 4a to 4c in a differential gear. This may comprise, in particular, a motor vehicle differential gear, in particular a rigid axle of a vehicle. The differential gear has a differential cage 1 drivable through an input shaft (not shown). For this purpose, the input shaft has a bevel wheel, which combs with a crown wheel 1B arranged on the cage 1. The cage 1 itself is rotatably mounted within the differential gear through two bearings. Differential gear wheels 2A, 2B, here for example bevel wheels, are arranged within the differential cage 1. Of these, at least two (gear wheel 2A) are rotatably mounted on a differential pin 3, and two (gear wheel 2B) are firmly connected in a positive-locking manner with one axle shaft 4 each. Thereby, the output shafts 4 are rotatably drivable. The differential pin 3 is firmly fixed in the differential cage 1, at least axially. The output shafts 4 comprise in particular axle shafts or side shafts of a vehicle axle.

For the axial fixing of the shaft 4 and the gear wheel 2B, in each case, one axial stop element 5, here for example in the form of a C-clip, is provided. In each case, these are inserted radially into a circumferential groove 4A of the respective shaft 4. For this purpose, initially, the shaft 4 must be axially introduced into the differential cage 1 and the respective gear wheel 2B, such that the circumferential groove 4A is accessible inside the differential cage 1 through a window-like opening of the differential cage 1 (not shown). Then, the axial stop element 5 may be attached radially on the shaft 4 or in the circumferential groove 4A. Then, in order to prevent the axial stop element 5 from slipping from the shaft 4, the securing element 7 is attached through the window-like opening radially on the axial stop element 5 and the shaft 4. Thus, the axial stop element 5 is radially secured. Alternatively, the securing element 7 initially may be attached to the axial stop element 5, in order to then attach these two to the respective shaft 4. The disassembly takes place in reverse order.

In contrast to the embodiment of the state of the art shown in FIG. 1, with the securing element 7 in accordance with the invention, the assembly and disassembly of the differential gear is significantly simplified. In particular, it is no longer necessary to remove the differential pin 3 from the differential cage 1 prior to disassembly. The axial stop element 5 is then able to be installed and removed in the operating position (shown) of the shafts 4. For removal, only the securing element 7 needs to be removed from the axial stop element 5.

If the securing element 7 is designed in accordance with FIGS. 4 to 4c, the securing element 7 may be removed from the respective shaft 4 together with the axial stop element 5. This is effected by the fact that the radial holding force of the securing element 7 is overcome, and both components together are radially disengaged from the shaft 4.

The differential gear shown in FIG. 5 comprises, as an example, a so-called “bevel differential gear.” Of course, the securing element may also be provided for any differentially constructed differential gear for the radial securing of an axial stop element. Accordingly, the differential gear may also be designed in the form of a spur wheel differential gear or a helical wheel differential gear. The differential gear wheels 2A, 2B are then designed in a manner corresponding to the respective type of differential construction, such as a spur wheel, bevel wheel, worm wheel, etc.

In FIGS. 3, 4 and 5, a longitudinal axis is marked with the reference sign L. Thereby, the term “axial” can be understood in particular as “along a longitudinal axis L” or “parallel to a longitudinal axis L.” Thereby, the term “radial” can be understood in particular as “orthogonal to a longitudinal axis L.”

It is noted that the previously described securing element is not limited to use in a differential gear. Rather, it may be employed in a variety of applications, for example, for the radial securing of an axial stop element in a change speed gearbox of a vehicle, or in a printing machine gearbox, or in a tool machine gearbox, etc. or even outside of a gearbox.

Modifications and variations can be made to the embodiments illustrated or described herein without departing from the scope and spirit of the invention as set forth in the appended claims.

1-15. (canceled)

16. A securing element for securing an axial stop element radially attached to shaft, the securing element comprising:
a first-type spring axle journal configured such that in an attached state of the securing element on the shaft, the first spring axle journal exerts a radial holding force on the axial stop element.

17. The securing element as in claim 16, wherein the first-type spring axle journal at least partially encircles the axial stop element in the attached state of the securing element.

18. The securing element as in claim 17, further comprising another of the first-type spring axle journal that at least partially encircles the axial stop element in the attached state of the securing element, the first-type spring axle journals extending in opposite directions from a connection piece, the connection piece further comprising a molding that fits into a circumferential groove on the shaft to secure the securing element in position on the shaft.

19. The securing element as in claim 18, wherein the molding has a width in the axial direction that is greater than a width of the first-type second axle journals.

20. The securing element as in claim 18, further comprising a second-type spring axle journal that is axially spaced from the first-type spring axle journals and at least partially encircles the axial stop element in the attached state of the securing element.

21. The securing element as in claim 20, further comprising another of the second-type spring axle journal that at least partially encircles the axial stop element in the attached state of the securing element, the second-type spring axle journals extending in opposite directions from the connection piece.

22. The securing element as in claim 18, wherein the first-type of spring axle journals encircle the axial stop element by less than 180 degrees in the attached state of the securing element.

23. The securing element as in claim 18, wherein the first-type of spring axle journals encircle the axial stop element by 180 degrees or more in the attached state of the securing element.

24. The securing element as in claim 18, wherein the first-type of spring axle journals completely encircle the axial stop element in the attached state of the securing element.

25. The securing element as in claim 16, further comprising an axially disposed contact surface that engages against a side surface of the axial stop element in the attached state of the securing element.

26. The securing element as in claim 25, comprising a pair of the axially disposed contact surfaces configured to contact opposite side surfaces of the axial stop element relative to the shaft.

27. The securing element as in claim 18, wherein the first-type of spring axle journals further comprise a positive-locking element at a radial end thereof that is configured to engage with a complimentary positive-locking member on the axial stop element or on the shaft.

28. An axial stop element in combination with the securing element of claim 27, the axial stop element comprising a positive-locking member that engages with the positive-locking element at the radial end of the first-type of spring axle journals.

29. A shaft device, comprising a shaft element having an axial stop element attached thereto with a securing element according to claim 16.

30. A motor vehicle differential gear, comprising:
an input drive shaft, two output shafts, and a rotatable drive cage driven by the input drive shaft;
differential gear wheels within the drive cage that connected in a positive-locking manner with a respective output shaft;
each differential gear wheel fixed on a respective output shaft with an axial stop element; and
the axial stop element secured to the shaft with an axial stop element in accordance with claim 16.
